(19) United States
(12) Patent Application Publication
(10) Pub. No.: US 2026/0035885 A1
(43) Pub. Date: Feb. 5, 2026

(54) Hydraulic Actuator for Work Machine

(71) Applicant: Caterpillar Inc., Peoria, IL (US)

(72) Inventors: Rameshkrishnan LAKSHMINARAYANAN, Chennai (IN); Jerin Sahaya GEORGE, Chennai (IN); Kurt Steven GOSLOVICH, Naperville, IL (US)

(73) Assignee: Caterpillar Inc., Peoria, IL (US)

(21) Appl. No.: 19/099,873

(22) PCT Filed: Jul. 26, 2023
(86) PCT No.: PCT/US2023/070998

§ 371 Date: Jan. 30, 2025

(30) Foreign Application Priority Data
Aug. 18, 2022 (IN) 202211046915

(51) Int. Cl. E02F 9/22; F15B 15/22

(52) U.S. Cl. CPC E02F 9/2271; F15B 15/222

(57) ABSTRACT

A hydraulic actuator (200) for a work machine (100) includes a rod member (206) defining an annular shoulder (208), a piston (230) coupled to the rod member (206), and a collar (500) engaging with the rod member (206) and the piston (230). The collar (500) includes a body (502) defining a first end (504) and a second end (506). The body (502) includes a cylindrical portion (508) extending from the first end (504) of the body (502) towards the second end (506) of the body (502) and defining a first inner diameter (D1). The cylindrical portion (508) extends along a longitudinal axis (A1) of the hydraulic actuator (200). The body (502) also includes a flange (510) disposed at the second end (506) of the body (502) and radially extending from the cylindrical portion (508). The flange (510) defines a second inner diameter (D2). The first inner diameter (D1) of the cylindrical portion (508) is greater than the second inner diameter (D2) of the flange (510). The flange (510) is axially disposed between the piston (230) and the annular shoulder (208) defined by the rod member (206).

### TECHNICAL FIELD

The present disclosure relates to a hydraulic actuator for a work machine.

### BACKGROUND

A work machine, such as a hydraulic mining shovel or a backhoe loader, may be used to perform one or more work operations at a worksite. Such work machines include a work implement for performing the work operations. Typically, the work implement is lowered, raised, or moved by one or more hydraulic actuators. For example, a boom, a stick, and the work implement of the work machine may be movable by a corresponding hydraulic actuator. Components of the hydraulic actuator may be subjected to impact loading during an operation of the hydraulic actuator. Further, when the hydraulic actuator moves between an extended position and a retracted position, one or more actuator components may contact or impact an adjacently disposed actuator component. If an interface of such actuator components is not provided with a suitable cushioning element, the contact between the actuator components may cause a rattling effect and may also cause operator discomfort. In some cases, the actuator components may undergo wear and tear at the interface of the actuator components, which is not desirable.

In an example, a cushion member may be disposed between two adjacent actuator components. However, in order to accommodate the cushion member, a dimension, such as a diameter, of one or more actuator components may have to be altered which may affect a structural integrity of the hydraulic actuator. In some cases, additional components, such as a bearing, may be used to retain a conventional cushion member that may increase a number of part numbers associated with the hydraulic actuator.

U.S. Pat. No. 10,451,093 describes a fluid pressure cylinder includes a cushion bearing provided movably on an outer periphery of the piston rod, a flange portion provided on the piston rod by facing the piston with the cushion bearing between them, and a collar provided movably in a radial direction on the outer periphery of the piston rod between the cushion bearing and the flange portion. End surfaces of the cushion bearing, and the collar are inclined symmetrically to a center axis of the piston rod, and end surfaces of the flange portion and the collar are formed having plane shapes crossing the center axis.

### SUMMARY OF THE DISCLOSURE

In an aspect of the present disclosure, a hydraulic actuator for a work machine is provided. The hydraulic actuator includes a rod member defining an annular shoulder. The hydraulic actuator also includes a piston coupled to the rod member. The hydraulic actuator further includes a collar engaging with the rod member and the piston. The collar includes a body defining a first end and a second end. The body includes a cylindrical portion extending from the first end of the body towards the second end of the body and defining a first inner diameter. The cylindrical portion extends along a longitudinal axis of the hydraulic actuator and is circumferentially disposed around the rod member of the hydraulic actuator. The body also includes a flange disposed at the second end of the body and radially extending from the cylindrical portion. The flange defines a second inner diameter. The first inner diameter of the cylindrical portion is greater than the second inner diameter of the flange. The flange is axially disposed between the piston of the hydraulic actuator and the annular shoulder defined by the rod member. The flange is circumferentially disposed around the rod member of the hydraulic actuator.

In another aspect of the present disclosure, a work machine is provided. The work machine includes a frame. The work machine also includes a linkage assembly coupled to the frame. The work machine further includes at least one hydraulic actuator coupled to the linkage assembly. The hydraulic actuator includes a rod member defining an annular shoulder. The hydraulic actuator also includes a piston coupled to the rod member. The hydraulic actuator further includes a collar engaging with the rod member and the piston. The collar includes a body defining a first end and a second end. The body includes a cylindrical portion extending from the first end of the body towards the second end of the body and defining a first inner diameter. The cylindrical portion extends along a longitudinal axis of the hydraulic actuator and is circumferentially disposed around the rod member of the hydraulic actuator. The body also includes a flange disposed at the second end of the body and radially extending from the cylindrical portion.

The flange defines a second inner diameter. The first inner diameter of the cylindrical portion is greater than the second inner diameter of the flange. The flange is axially disposed between the piston of the hydraulic actuator and the annular shoulder defined by the rod member. The flange is circumferentially disposed around the rod member of the hydraulic actuator.

Other features and aspects of this disclosure will be apparent from the following description and the accompanying drawings.

### BRIEF DESCRIPTION OF THE DRAWINGS

FIG. 1 is a schematic side view of a work machine, according to an example of the present disclosure;

FIG. 2 is a cross-sectional view of a hydraulic actuator for the work machine of FIG. 1 in a retracted state, according to an example of the present disclosure;

FIG. 3 is a cross-sectional view of the hydraulic actuator for the work machine of FIG. 1 in an extended state;

FIG. 4 is an exploded view of a rod member, a piston, and a collar associated with the hydraulic actuator of FIG. 2; and

FIG. 5 is a perspective view of the collar of FIG. 4, according to an example of the present disclosure;

### DETAILED DESCRIPTION

Wherever possible, the same reference numbers will be used throughout the drawings to refer to the same or like parts.

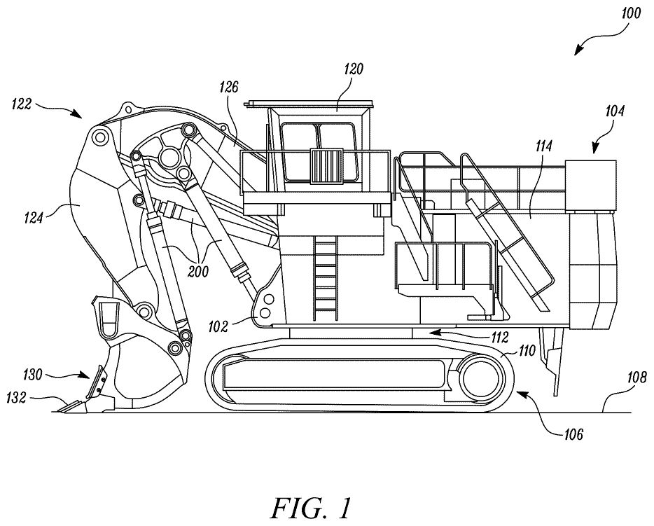

Referring to FIG. 1, a schematic side view of an exemplary work machine 100 is illustrated. In the illustrated example of FIG. 1, the work machine 100 is a hydraulic mining shovel. In another example, the work machine 100 may include a backhoe loader. Alternatively, the work machine 100 may include any other machine having a hydraulic actuator, without any limitations. The work machine 100 may perform one or more work operations associated with an industry, such as, mining, construction, farming, transportation, or any other industry known in the art. In an example, the work machine 100 may perform one or more work operations, such as, carrying/transporting work aggregates from a worksite, scooping/excavating the work aggregates from the worksite, and the like.

The work machine 100 includes a frame 102. The work machine 100 also includes a superstructure (or upper carriage) 104, such that the frame 102 is defined by the superstructure 104. The work machine 100 further includes an undercarriage 106. The undercarriage 106 includes a number of ground engaging members 110 for propelling the work machine 100 on a ground surface 108. The ground engaging members 110 are embodied as tracks herein. Alternatively, the ground engaging members 110 may include wheels or drums.

A slewing gear device (swing gear device) 112 is mounted between the superstructure 104 and the undercarriage 106 to enable a relative rotary movement to occur between the superstructure 104 and the undercarriage 106. The work machine 100 further includes a power module (not shown) disposed within an enclosure 114. The power module may provide operating power to various components of the work machine 100 for operational and mobility requirements. The power module may include an engine (such as, an internal combustion engine), a battery, and the like. Further, the work machine 100 includes an operator cabin 120 supported by the frame 102. The operator cabin 120 may include one or more controls (not shown), such as, joysticks, pedals, levers, buttons, switches, knobs, audio visual devices, operator consoles, a steering wheel, and the like. The controls may enable the operator to control the work machine 100 during operation.

The work machine 100 further includes a linkage assembly 122 coupled to the frame 102. The linkage assembly 122 includes one or more linkage members 124, 126. In the illustrated example of FIG. 1, the linkage member 124 includes a stick and the linkage member 126 includes a boom. The linkage member 124 is pivotally connected to the linkage member 126. The linkage member 126 of the linkage assembly 122 may be pivotally connected to the superstructure 104 of the work machine 100. The linkage assembly 122 further includes a work implement 130 movably coupled with the linkage member 124. In the illustrated example of FIG. 1, the work implement 130 is embodied as a face shovel. However, in other examples, the work machine 100 may include any other type of work implement, without any limitations. The work implement 130 includes a number of ground engaging elements 132 that engage with the ground surface 108. The ground engaging elements 132 may include cutting tools or tips.

The present disclosure is related to one or more hydraulic actuators 200 for the work machine 100. The one or more hydraulic actuators 200 are coupled to the linkage assembly 122. In one example, the hydraulic actuator 200 may be coupled between the superstructure 104 and the linkage member 126 to move the linkage member 126 relative to the superstructure 104. In another example, the hydraulic actuator 200 may be coupled between the superstructure 104 and the linkage member 124 to move the linkage member 124 relative to the superstructure 104. In yet another example, the hydraulic actuator 200 may be coupled between the linkage member 126 and the work implement 130 to move the work implement 130 relative to the linkage member 126. It should be further noted that the hydraulic actuator 200 may be used at any other location of the work machine 100 to move one component of the work machine 100 relative to another component of the work machine 100. In some examples, the hydraulic actuator 200 may include a suspension cylinder of the work machine 100.

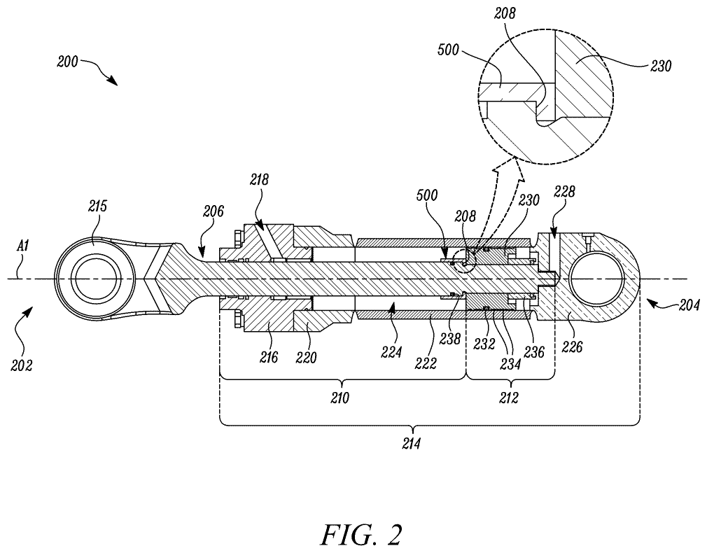

Referring to FIG. 2, a cross-sectional view of the hydraulic actuator 200 for the work machine 100 is illustrated, according to an example of the present disclosure. The hydraulic actuator 200 defines a rod end 202. The hydraulic actuator 200 also defines a cylinder end 204. The rod end 202 is disposed opposite to the cylinder end 204. The hydraulic actuator 200 further defines a longitudinal axis “A1”.

The hydraulic actuator 200 includes a rod member 206 defining an annular shoulder 208. The rod end 202 is defined by the rod member 206. The rod member 206 extends along the longitudinal axis “A1” of the hydraulic actuator 200. The rod member 206 includes a stepped design. The rod member 206 includes a first portion 210 and a second portion 212, such that the annular shoulder 208 connects the first portion 210 to the second portion 212. In other words, the annular shoulder 208 is disposed at an intersection of the first and second portions 210, 212. The rod member 206 also includes a first bracket 215 disposed proximate to the rod end 202. The first bracket 215 may allow coupling of the hydraulic actuator 200 to a portion of the work machine 100.

The hydraulic actuator 200 further includes a cylinder 214. The cylinder end 204 is defined by the cylinder 214. The cylinder 214 includes a head portion 216. The head portion 216 is circumferentially disposed around the first portion 210 of the rod member 206. The head portion 216 defines a first fluid port 218 for inlet/outlet of a hydraulic fluid. The hydraulic fluid may include any type of hydraulic oil including one or more additives. Further, the cylinder 214 includes a flange portion 220 disposed adjacent to the head portion 216. The flange portion 220 is circumferentially disposed around the first portion 210 of the rod member 206. The head portion 216 and the flange portion 220 are located proximal to the rod end 202. Further, the head portion 216 and the flange portion 220 may be coupled to each other by a suitable joining process, such as, welding.

The cylinder 214 further includes a tube 222 extending along the longitudinal axis “A1” of the hydraulic actuator 200. The tube 222 is generally cylindrical in shape. The tube 222 is circumferentially disposed around the rod member 206. Further, the flange portion 220 and the tube 222 may be coupled to each other by a suitable joining process, such as, welding. Furthermore, the tube 222 and the flange portion 220 together define a chamber 224. The tube 222 defines a second fluid port 228 for inlet/outlet of hydraulic fluid therethrough. During the operation of the hydraulic actuator, the hydraulic fluid may be received within the chamber 224. Moreover, the cylinder 214 includes a second bracket 226 disposed proximate to the cylinder end 204. The second bracket 226 that may allow coupling of the hydraulic actuator 200 to a portion of the work machine 100. The second fluid port 228 is defined by the second bracket 226.

The hydraulic actuator 200 further includes a piston 230 coupled to the rod member 206. A piston seal 232 may be disposed between the piston 230 and the tube 222 to maintain a sealing contact between the piston 230 and the tube 222. Further, one or more wear rings 234 may be disposed between the piston 230 and the tube 222. As shown in FIG. 2, the hydraulic actuator 200 further includes a lock nut 236 located adjacent to the piston 230 and proximal to the cylinder end 204. The lock nut 236 may prevent any movement or loosening of the piston 230 due to vibrations and/or rotation. Further, the lock nut 236 may limit a travel of the piston 230 and the rod member 206 toward the cylinder end 204.

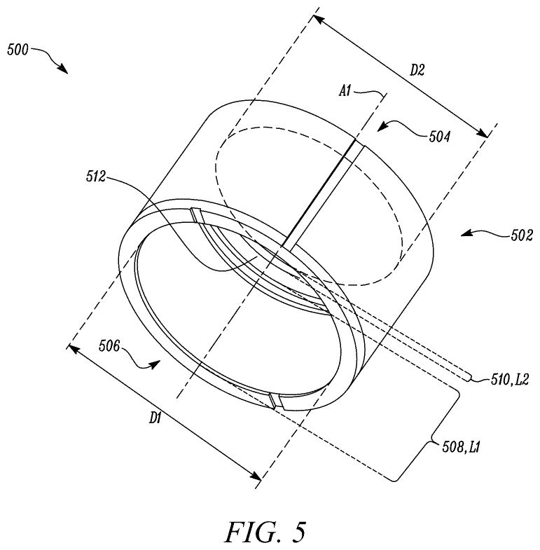

The hydraulic actuator 200 further includes a collar 500 engaging with the rod member 206 and the piston 230. The collar 500 will be described in detail below with reference to FIG. 5.

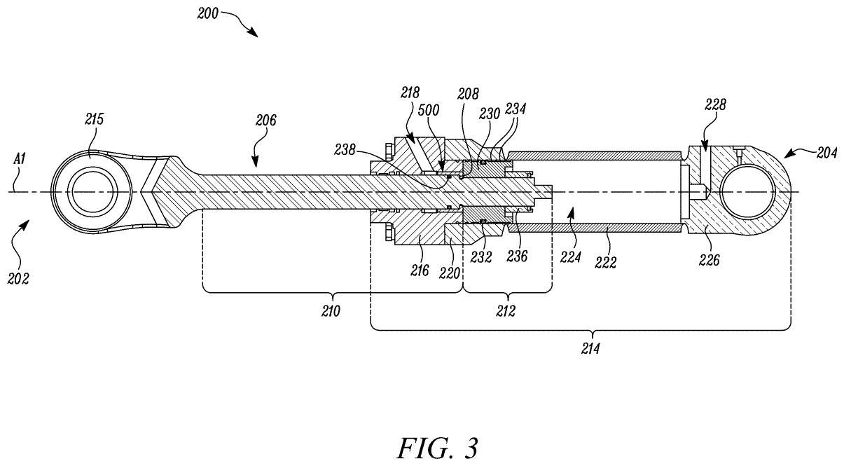

Referring now to FIGS. 2 and 3, the hydraulic actuator 200 may be movable between a retracted state and an extended state. Specifically, the piston 230 as well as the rod member 206 may move along the longitudinal axis “A1” relative to the tube 222 in order to switch from the retracted state to the extended state, or vice versa. The hydraulic actuator 200 is illustrated in the retracted state in FIG. 2. In the retracted state, the first and second portions 210, 212 of the rod member 206 may be received within the tube 222. Further, in the retracted state, the piston 230 may be located proximal to the cylinder end 204.

Referring to FIG. 3, a cross-sectional view of the hydraulic actuator 200 is illustrated. The hydraulic actuator 200 is illustrated in the extended state in FIG. 3. In the extended state, some portion of the first portion 210 of the rod member 206 may be disposed outside the tube 222. Further, in the extended state, the piston 230 may be proximal to the rod end 202 of the hydraulic actuator 200. In some examples, as the hydraulic actuator 200 moves from the retracted state to the extended state, the piston 230 impacts the head portion 216. In such a situation, the collar 500 may function as a cushion for the piston 230 as the piston 230 impacts the head portion 216. Further, in the extended state, the collar 500 may be received within the head portion 216. More particularly, the collar 500 may be circumferentially disposed between the head portion 216 and the rod member 206. In some examples, a sealing ring 238 may be circumferentially disposed within the first portion 210 of the rod member 206, such that the sealing ring 238 may be in contact with the collar 500.

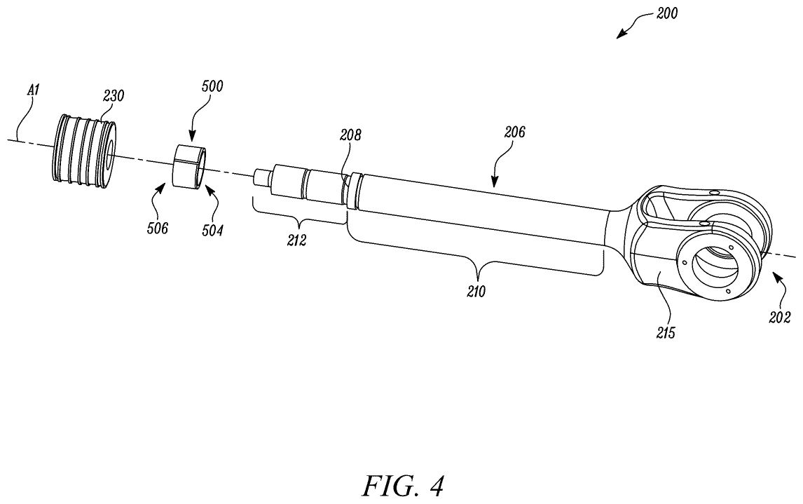

Referring to FIGS. 4 and 5, the collar 500 includes a body 502 defining a first end 504 and a second end 506. When the collar 500 is assembled with the piston 230 and the rod member 206, the first end 504 is disposed proximate to the piston 230 and the second end 506 is distal from the piston 230. In some examples, the body 502 includes a one-piece design. In other words, the body 502 may be an integral component. In alternate examples, the body 502 may include multiple pieces that are joined together. Further, the body 502 is made of a metallic material. In some examples, the metallic material may include one or more metals, one or more alloys, or combinations thereof. For example, the body 502 may be made of medium carbon steel, alloy steel, and the like, without any limitations. In an example, a suitable process, such as, a nitriding process or any other process may be performed on the body 502 to improve a hardness thereof.

Referring now to FIG. 5, the body 502 includes a cylindrical portion 508 extending from the first end 504 of the body 502 towards the second end 506 of the body 502. Further, the cylindrical portion 508 defines a first inner diameter “D1”. The cylindrical portion 508 extends along the longitudinal axis “A1” of the hydraulic actuator 200 (see FIGS. 2 and 3) and is circumferentially disposed around the rod member 206 (see FIGS. 2 and 3) of the hydraulic actuator 200.

More particularly, the cylindrical portion 508 is circumferentially disposed around the first portion 210 (see FIGS. 2 and 3) of the rod member 206. Further, the cylindrical portion 508 defines a first length “L1” along the longitudinal axis “A1”.

The body 502 further includes a flange 510 disposed at the second end 506 of the body 502 and radially extending from the cylindrical portion 508. Further, the flange 510 defines a second inner diameter “D2”. In the illustrated example of FIG. 5, the first inner diameter “D1” of the cylindrical portion 508 is greater than the second inner diameter “D2” of the flange 510. The flange 510 is circumferentially disposed around the rod member 206 of the hydraulic actuator 200. Specifically, the flange 510 and the piston 230 (see FIGS. 2 and 3) are circumferentially disposed around the second portion 212 of the rod member 206.

Further, when the collar 500 engages with the piston 230 and the rod member 206, an inner surface 512 of the flange 510 is in contact with the annular shoulder 208 (see FIGS. 2 and 3) and an outer surface (not shown) of the flange 510 is in contact with the piston 230. Moreover, the flange 510 is axially disposed between the piston 230 of the hydraulic actuator 200 and the annular shoulder 208 defined by the rod member 206. In other words, the flange 510 is retained between the annular shoulder 208 and the piston 230. Further, the flange 510 defines a second length “L2” along the longitudinal axis “A1”. The first length “L1” is greater than the second length “L2”. In some examples, the first length “L1” may be at least five times greater than the second length “L2”.

### INDUSTRIAL APPLICABILITY

The present disclosure relates to the hydraulic actuator 200 associated with the work machine 100. The hydraulic actuator 200 includes the collar 500 disposed between the rod member 206 and the piston 230. The collar 500 may function as an orifice to control a velocity of the hydraulic actuator 200 as well as impact loads during end strokes of the hydraulic actuator 200. Specifically, the collar 500 may provide a variable orifice curve to provide smooth cushioning effect to the piston 230, when the piston 230 impacts the head portion 216 during the end strokes of the hydraulic actuator 200. Thus, overall, the collar 500 described herein may allow improved control of the velocity of the hydraulic actuator 200, provide a cushioning effect, prevent hard stop of the hydraulic actuator 200, and may assist in deceleration thereof.

The collar 500 includes the cylindrical portion 508 and the flange 510. The flange 510 of the collar 500 may engage with the annular shoulder 208, thereby retaining the collar 500 between the rod member 206 and the piston 230. Thus, the collar 500 may not require additional components for retention of the collar 500 within the hydraulic actuator 200.

The collar 500 described herein includes a one-piece design. Further, the collar 500 may be cost-effective to incorporate in the hydraulic actuator 200. Furthermore, the collar 500 may be easily serviceable and the collar 500 may be easy to access. Moreover, the collar 500 includes a design that may allow easy assembly of the collar 500. Additionally, the collar 500 may be accommodated within a compact space. Further, incorporation of the collar 500 within the hydraulic actuator 200 may not require modification to a diameter of the rod member 206. Thus, the collar 500 may not affect a structural strength of the hydraulic actuator 200. The collar 500 may be retrofitted in existing hydraulic actuators with minimum modifications.

While aspects of the present disclosure have been particularly shown and described with reference to the embodiments above, it will be understood by those skilled in the art that various additional embodiments may be contemplated by the modification of the disclosed work machines, systems and methods without departing from the spirit and scope of the disclosure. Such embodiments should be understood to fall within the scope of the present disclosure as determined based upon the claims and any equivalents thereof.

1. A hydraulic actuator (200) for a work machine (100), the hydraulic actuator (200) comprising:
a rod member (206) defining an annular shoulder (208);
a piston (230) coupled to the rod member (206); and
a collar (500) engaging with the rod member (206) and the piston (230), the collar (500) including:
a body (502) defining a first end (504) and a second end (506), the body (502) including:
a cylindrical portion (508) extending from the first end (504) of the body (502) towards the second end (506) of the body (502) and defining a first inner diameter (D1), wherein the cylindrical portion (508) extends along a longitudinal axis (A1) of the hydraulic actuator (200) and is circumferentially disposed around the rod member (206) of the hydraulic actuator (200); and
a flange (510) disposed at the second end (506) of the body (502) and radially extending from the cylindrical portion (508), the flange (510) defining a second inner diameter (D2), wherein the first inner diameter (D1) of the cylindrical portion (508) is greater than the second inner diameter (D2) of the flange (510), wherein the flange (510) is axially disposed between the piston (230) of the hydraulic actuator (200) and the annular shoulder (208) defined by the rod member (206); and wherein the flange (510) is circumferentially disposed around the rod member (206) of the hydraulic actuator (200).

2. The hydraulic actuator (200) of claim 1, wherein the body (502) includes a one-piece design.

3. The hydraulic actuator (200) of claim 1, wherein the body (502) is made of a metallic material.

4. The hydraulic actuator (200) of claim 1, wherein the rod member (206) includes a first portion (210) and a second portion (212), such that the annular shoulder (208) connects the first portion (210) to the second portion (212), and wherein the cylindrical portion (508) is circumferentially disposed around the first portion (210) of the rod member (206).

5. The hydraulic actuator (200) of claim 4, wherein the flange (510) and the piston (230) are circumferentially disposed around the second portion (212) of the rod member (206).

6. A work machine (100) comprising:
a frame (102);
a linkage assembly (122) coupled to the frame (102); and
at least one hydraulic actuator (200) coupled to the linkage assembly (122), the at least one hydraulic actuator (200) including:
a rod member (206) defining an annular shoulder (208);
a piston (230) coupled to the rod member (206); and
a collar (500) engaging with the rod member (206) and the piston (230), the collar (500) including:
a body (502) defining a first end (504) and a second end (506), the body (502) including:
a cylindrical portion (508) extending from the first end (504) of the body (502) towards the second end (506) of the body (502) and defining a first inner diameter (D1), wherein the cylindrical portion (508) extends along a longitudinal axis (A1) of the hydraulic actuator (200) and is circumferentially disposed around the rod member (206) of the hydraulic actuator (200); and
a flange (510) disposed at the second end (506) of the body (502) and radially extending from the cylindrical portion (508), the flange (510) defining a second inner diameter (D2), wherein the first inner diameter (D1) of the cylindrical portion (508) is greater than the second inner diameter (D2) of the flange (510), wherein the flange (510) is axially disposed between the piston (230) of the hydraulic actuator (200) and the annular shoulder (208) defined by the rod member (206); and wherein the flange (510) is circumferentially disposed around the rod member (206) of the hydraulic actuator (200).

7. The work machine (100) of claim 6, wherein the body (502) includes a one-piece design.

8. The work machine (100) of claim 6, wherein the body (502) is made of a metallic material.

9. The work machine (100) of claim 6, wherein the rod member (206) includes a first portion (210) and a second portion (212), such that the annular shoulder (208) connects the first portion (210) to the second portion (212), and wherein the cylindrical portion (508) is circumferentially disposed around the first portion (210) of the rod member (206).

10. The work machine (100) of claim 9, wherein the flange (510) and the piston (230) are circumferentially disposed around the second portion (212) of the rod member (206).
